(19) United States
(12) Patent Application Publication
(10) Pub. No.: US 2008/0251197 A1
(43) Pub. Date: Oct. 16, 2008

(54) Apparatus and Method for Printing on a Support

(75) Inventor: Luca Gortan, Udine (IT)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: GORTAN SRL, Udine (IT)

(21) Appl. No.: 12/091,821

(22) PCT Filed: Oct. 26, 2006
(86) PCT No.: PCT/EP06/67832

§ 371 Date: Apr. 28, 2008

(30) Foreign Application Priority Data
Oct. 28, 2005 (IT) UD2005A000184

(51) Int. Cl. B32B 37/00

(52) U.S. Cl. 156/277; 156/384

(57) ABSTRACT

An apparatus and method are provided for printing writings, drawings or images on a large-size support, even more than 2,500 cm². The apparatus includes a sublimation chamber, inside which the support to be printed is able to be disposed and in which a heating plate is present, able to heat the support to a pre-determined temperature. A sublimation paper, on which the writings, drawings or images to be printed are contained, is disposed between the heating plate and the support to be printed, and a layer or sheet of porous or transpirant material is interposed between the heating plate and the sublimation paper.

### FIELD OF THE INVENTION

The present invention concerns an apparatus and a method for printing writings, drawings or images on a support, even rigid, such as for example a furnishing element, or the surface of a structure, even large-size, that is, even much more than 2,500 cm², by means of vacuum sublimation at high temperature, that is, around 180° C. The support to be printed preferably comprises a layer of plastic material, for example polymeric, which defines the surface on which the writings, drawings or images are to be printed.

### BACKGROUND OF THE INVENTION

The sublimation printing method as currently known consists of taking the material on which the drawing, writing or image is to be transferred to high temperatures, at the same time keeping it in contact with the sublimation paper, which contains the drawing, writing or image to be transferred onto the surface to be printed. Moreover, the sublimation method provides that the material to be printed and the sublimation paper/paper are held one against the other, and the latter against the heating plate, with a very great pressure, about 3,800 bar, and for a period of time varying between 40 minutes and 45 minutes. This pressure is advantageously obtained by creating a vacuum inside the sublimation chamber.

Due to the effect of the temperature and the pressure, the pigments present on the sublimation papers sublimate, passing from the solid state to the gaseous state, and penetrate inside the plastic material disposed on the surface of the support to be printed. After penetrating inside the plastic material, the pigments again pass to the solid state, fixing themselves in the material, due to the effect of a controlled lowering of the temperature.

If the surface layer to be printed consists of a polymeric material, such as for example Corian®, the need to take it to a temperature of around 180° C. is due to its non-porous nature. In fact, in this polymeric material, it is only by exceeding the temperature of 165° C. that it is possible to form porosity through which the pigments can penetrate in the gaseous state.

During the period of sublimation, which as we have seen occurs at a determinate pressure and which lasts about 40-45 minutes, the controlled lowering of the temperature occurs which allows an adequate fixture of the pigments in the plastic material.

This known method has the disadvantage, however, that in practice satisfactory results, that is, with good clarity of the sign and the image, are only obtained if the size of the surface of the support to be printed is not more than about 2,500 cm² (for example, 500 mm×500 mm per side).

When these sizes are exceeded, on the contrary, the effect of the pressure and of the temperature, necessary so that the sublimation of the pigments can occur, leads to the formation of sublimatic gas bubbles between the support to be printed and the sublimation paper. The effect of the gas bubbles is to make unstable the process of transferring the sublimation gases inside the polymeric material which constitutes the surface layer of the support to be printed. This has led, until now, to the formation of printed areas in which the image appears to be doubled and/or blurred.

One known solution, which is currently adopted to try to obviate this unwanted phenomenon, is to press the support to be printed against the sublimation paper more strongly. To do this, structures are built specifically to be placed above the support to be printed, so as to increase the pressure exerted by the machine to sublimate the support.

However, this known solution does not guarantee a perfect print quality. In fact, the sublimation gases can be released at such a pressure as to manage in any case to contrast the force of the machine, even though it is great, and thus the gas bubbles which compromise the printing process are in any case formed.

Moreover, from GB-A-1,363,145 it is known a dyeing process which comprises the steps of evacuating the inside of a composite of a heatable plate, a laminate of a transfer sheet carrying a colouring composition containing one dyestuff which is not a fibre-reactive disperse dye and which can sublimate, melt or evaporate, and of a material to be dyed, and a sheet of porous material which is heat durable and is not dyed during the dyeing process, adjacent the material to be dyed, and a second plate, and heating at a pressure of less than 100 mm Hg, whereby the dyed material is obtained by sublimation, melting or evaporation of the dyestuff. The porous material is disposed directly into contact with the material to be dyed, on the opposite side of the latter with respect to the transfer sheet. In other words, the material to be dyed is disposed between the transfer sheet and the porous material.

Moreover, from U.S. Pat. No. 4,242,092 it is known a method of sublimatic printing on sheet and flexible structures such as carpets and tiles, which are tufted or non-woven, wherein the color is sublimatic dyestuff carried by an air permeable printing foil and this is placed over the textile structure with the dyestuff facing the textile structure. Heat is applied to vaporize the dyestuff and a pressure differential across the textile structure causes an air flow through the sheet structure and printing foil to affect penetration of the dye vapor into the structure. The dyestuff deposits on the textile fibres and filaments in the pattern it appeared on the printing foil.

Both this two last-mentioned known solutions have the disadvantage that they do not avoid the formation of sublimatic gases between the transfer sheet and the material to be dyed, so that they are not usable for printing writings, drawings or images on large-size surfaces and they cannot permit to obtain a high quality printing over the whole printed surface.

Purpose of the present invention is to achieve an apparatus and perfect a method which allow to print writings, drawings or images on support, even rigid, such as for example a furnishing element, or the surface of a structure, even large-scale, that is, even much more than 2,500 cm², by means of vacuum sublimation at high temperature, but avoiding the phenomenon of the formation of bubbles of sublimatic gases, and thus obtain a high quality printing over the whole printed surface.

Another purpose of the present invention is to achieve an apparatus and perfect a method as specified above, which are simple and reliable.

The Applicant has devised and perfected the present invention to overcome the shortcomings of the state of the art and to obtain these and other purposes and advantages.

### SUMMARY OF THE INVENTION

The present invention is set forth and characterized in the main claims, while the dependent claims describe other characteristics of the invention or variants to the main inventive idea.

In accordance with the above purposes, an apparatus for printing writings, drawings or images on support, even rigid, according to the present invention comprises a sublimation chamber inside which said rigid support to be printed is able to be disposed and in which there is a heating plate, able to heat said support to a determinate temperature, indicatively between about 165° C. and 200° C., advantageously around 180° C. A sublimation paper, or transfer sheet, on which the writings, drawings or images to be printed on the rigid support are disposed, is interposed between the heating plate and the rigid support. Means are provided to create a determinate pressure inside the sublimation chamber.

According to a characteristic of the present invention, a layer or sheet of porous or transpirant material is disposed between the heating plate and the sublimation paper.

The interposition of a layer or sheet of porous or transpirant material between the heating plate and the sublimation paper, i.e. not directly into contact with the support to be printed, allows the excess gases, deriving from the sublimation, to flow away easily from the combination of the support to be printed, the sublimation paper, the layer or the sheet of porous material and the heating plate, preventing unwanted bubbles of gas and/or residual air from forming.

The position of the layer or sheet of porous or transpirant material, with respect to both the support to be printed and the sublimation paper, is not an obvious and banal variation of the known solutions, but has evidenced unexpected and surprising effects and advantages. In fact the layer or sheet of porous or transpirant material between the heating plate and the sublimation paper, like in the present invention, functions as a sort of exit channel which allows the lateral exit of the sublimatic gases produced during the sublimation process. Without said layer or sheet of porous or transpirant material between the heating plate and the sublimation paper, the produced sublimatic gases would remain captured in the sublimation paper, also due to the determined pressure inside the sublimation chamber, so creating undesired bubble which would cause defects on the printing.

From practical trials carried out on different supports, rigid and otherwise, of different thicknesses and of sizes even much greater than 500 mm×500 mm and of different types of porous materials, clear signs and/or images have always been obtained, not blurred or doubled.

Such practical trials have been carried out by Applicant not only on different types of polymeric materials, but also on strips of Corian® polymeric material, produced by E.I. Du Pont de Nemours and Co., in different colors and with sizes even greater than 1,000 mm×2,000 mm, always obtaining the desired high quality results. During the trials porous materials of diverse nature and quality were used, such as for example fabrics, papers, stones, metals, ceramics and synthetic materials.

The use of a fabric was particularly advantageous, both mono-layer, multi-layer, compound, both warp and weft, polyester, with a percentage comprised between 45% and 50%, preferably 48%, and cotton, with a percentage comprised between 50% and 55%, preferably 52%, irrespective of the shade of color of the pigments used for printing.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a perspective view of an apparatus according to the present invention;

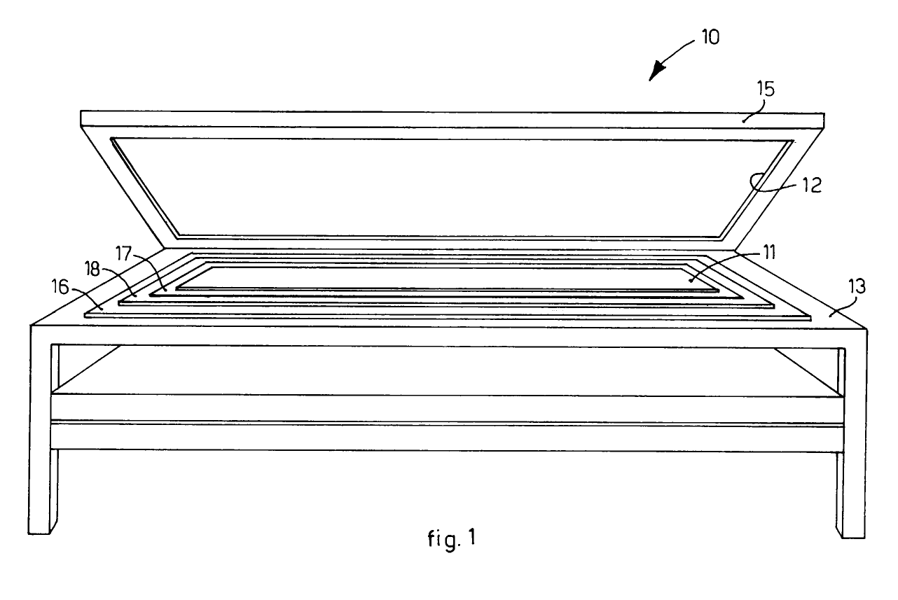

FIG. 2 is a perspective and partial view of the apparatus in FIG. 1.

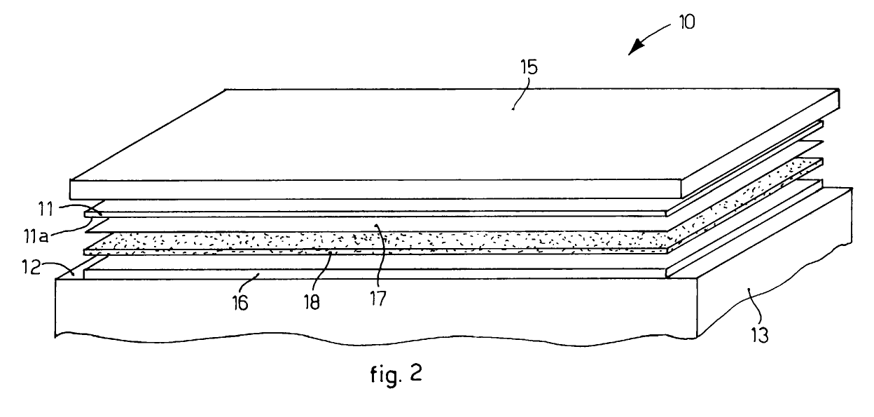

### DETAILED DESCRIPTION OF A PREFERENTIAL FORM OF EMBODIMENT OF THE INVENTION

With reference to the attached figures, an apparatus 10 according to the present invention for printing writings, drawings or images on a lower surface 11a of a rigid support 11 comprises a sublimation chamber 12, substantially of a known type, defined by a base structure 13 and a closing cover 15.

The rigid support 11 is able to be disposed inside the sublimation chamber 12, with the surface 11a to be printed facing downward. The surface 11a consists of at least a layer of polymeric material, for example Corian®, transparent polymeric paint or other polymer.

In the sublimation chamber 12 there is a heating plate 16, able to heat the rigid support 11 to a temperature of about 180° C. Between the heating plate 16 and the rigid support 11 there is a sublimation paper 17 interposed, on which the writings, drawings or images to be printed are contained.

Moreover, between the heating plate 16 and the sublimation paper 17 a layer or sheet 18 of porous or transpirant material is advantageously disposed, consisting for example of a fabric consisting of 48% polyester and 52% cotton.

A suction device of a known type, not shown in the drawings, is associated with the cover of the sublimation chamber 12 to create a determinate depression therein, for example in the order of 3,800 bar.

The functioning of the apparatus 10 as described heretofore, which defines the method according to the present invention, is as follows.

The sheet 18 of porous or transpirant material is disposed on the heating plate 16, and above it the sublimation paper 17. The support 11 is then positioned above the sublimation paper 17, with the surface 11a facing towards the latter.

The cover 15 is hermetically closed, the depression is created inside the sublimation chamber 12 and the heating plate 16 is heated. After a time of about 40-45 minutes, during which the colored pigments of the paper 17 are transferred, through sublimation, below the surface layer of the material that defines the surface 11a of the support 11, the temperature is lowered so that the pigments are fixed on the support 11.

It is clear that modifications and/or additions of parts or steps may be made to the apparatus and method as described heretofore, without departing from the scope of the present invention.

It is also clear that, although the present invention has been described with reference to a specific example, a person of skill in the art shall certainly be able to achieve many other equivalent forms of apparatus or method for printing writings, drawings or images on a large-size support, having the characteristics as set forth in the claims and hence all coming within the field of protection defined thereby.

1-9. (canceled)

10. An apparatus for printing writings, drawings or images on a support, the apparatus comprising a sublimation chamber inside which the support to be printed is able to be disposed, a heating plate disposed inside the sublimation chamber and able to heat the support to a pre-determined temperature, wherein a sublimation paper on which the writings, drawings or images to be printed are contained is disposed inside the sublimation chamber between the heating plate and the support, wherein a layer or sheet of porous or transpirant material is disposed inside the sublimation chamber and wherein the layer or sheet of porous or transpirant material is interposed between the heating plate and the sublimation paper.

11. The apparatus as in claim 10, wherein the support has a surface area of greater than 2,500 cm².

12. The apparatus as in claim 10, further comprising means to create a determinate depression inside the sublimation chamber.

13. The apparatus as in claim 10, wherein the layer or sheet comprises at least one material selected from fabrics, papers, stones, metals, ceramics, and synthetic materials.

14. The apparatus as in claim 10, wherein the layer or sheet comprises a polyester and cotton fabric, and wherein the fabric structure is selected from mono-layer or multi-layer, compound, and both warp and weft.

15. The apparatus as in claim 14, wherein the polyester comprises between 45% and 50%, and the cotton comprises between 50% and 55% of the fabric.

16. The apparatus as in claim 15, wherein the polyester comprises 48% and the cotton comprises 52% of the fabric.

17. A method for printing writings, drawings or images on a support having at least a large-size surface, even more than, by an apparatus having a sublimation chamber, inside which the support to be printed is able to be disposed, and having a heating plate disposed inside the sublimation chamber and able to heat the support to a pre-determined temperature, the method comprising disposing a sublimation paper on which the writings, drawings or images to be printed are contained inside the sublimation chamber between the heating plate and the support, disposing a layer or sheet of porous or transpirant material inside the sublimation chamber and on the heating plate, disposing the sublimation paper on the layer or sheet, and then disposing the support on the sublimation paper, with the surface of the support to be printed facing toward the sublimation paper.

18. The method as in claim 17, wherein the heating plate is heated so that at least the surface of the support reaches a pre-determined temperature between about 165° C. and 200° C., while in the sublimation chamber a depression is created able to hold the sublimation paper against the surface of the support.

19. The method as in claim 18, wherein the temperature is about 180° C.

20. The method as in claim 18, wherein the depression is about 3,800 bar.

21. The method as in claim 17, wherein the support surface has an area of greater than 2,500 cm².
